(19) United States
(12) Patent Application Publication
(10) Pub. No.: US 2008/0255862 A1
(43) Pub. Date: Oct. 16, 2008

(54) PREDICTIVE ASSET RANKING SCORE OF PROPERTY

(76) Inventors: Gregory A. Bailey, Baltimore, MD (US); J. Paul Williams, West Chester, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/734,110

(22) Filed: Apr. 11, 2007

(51) Int. Cl. G06Q 99/00; G06F 17/40

(52) U.S. Cl. 705/1; 707/104.1

(57) ABSTRACT

The predictive asset ranking system and process quantifies the condition of major components and sub-components of a property based on a systematic comparison of one major component against another utilizing analytical hierarchy analysis. The predictive asset ranking may be expressed as a value or score that may be used as a benchmark to compare one property to another property. The predictive asset ranking process applies multiple analytical hierarchies to the various attributes of a property. The analytical hierarchy may be based on an attribute weighing process and may include a series of qualitative questions indicative of attributes of the property. The predictive asset ranking system may be dynamic and may be customized for the particular asset being evaluated. When the system is customized, the process may automatically recalculate the weights and redistribute the points used in the predictive asset ranking analysis.

### FIELD OF THE INVENTION

The present invention relates to predictive asset ranking tools, and in particular, a predictive asset ranking system and process for quantifying the condition of a property and the condition of major components of a property, and also for providing an overall ranking (e.g., value or score) of the property that may be used as a benchmark in comparing a property to other properties. This technology is particularly suited, but by no means limited, for analyzing and quantifying the condition of a single family residential home and/or commercial buildings.

### BACKGROUND OF THE INVENTION

Buying a home could be the largest single investment a person will ever make in his or her lifetime. To minimize unpleasant surprises and unexpected difficulties, most home purchasers want to learn as much as possible about a newly constructed or existing home before they buy it.

A home inspection performed by a professional home inspector is one of the most popular means for potential home purchasers to learn about a home before they purchase it. A home inspection typically consists of a visual examination of the current condition of a house, i.e., the major components/systems of a house, from the roof to the foundation and everything in between. The standard home inspection and report will cover the condition of the home's components/systems, such as: heating system; central air conditioning system; interior; plumbing and electrical systems; the roof, attic and visible insulation; walls, ceilings, floors, windows and doors; the foundation, basement and structural components; etc.

A home inspector is typically familiar with the elements of home construction, proper installation, maintenance and home safety. The inspector knows the home's components/systems, how the systems and components are intended to function together, as well as why they fail. A home inspection may point out the positive aspects of a home, as well as identify the need for major repairs or builder oversights, as well as the need for maintenance to keep the home in good shape. The knowledge gained from a home inspection will typically allow potential purchasers to maximize their knowledge of the property in order to make intelligent decisions.

Home inspections are typically performed just prior to the home sale and the purchase contract the buyer and seller signed is typically contingent on the home inspection. Today, home inspections are typically obtain by the purchaser and are primarily for the purchaser's use.

A home inspection report typically includes written detailed information summarizing the condition of the property, describing its physical condition and indicating what components and systems may need major repair or replacement. The report may reveal problems and allow a purchaser to know in advance what to expect. For example, if a purchaser's budget is tight, or if the purchaser doesn't want to become involved in future repair work or replacements, this information will be important to them in deciding whether to complete a purchase. If major problems are found, a buyer will generally have the option based upon the inspection to: opt out of the purchase, ask for repairs or credit towards repairs or a purchase price reduction, etc.

The tendency has been, and will likely continue to be, increasing in demand for residential dwelling units. First time home buyers, second home buyers and empty-nester re-locators all help drive the real estate market. The housing stock is generally comprised of older homes and most of these transactions will include a home inspection. Also, most first time home purchasers, as well as many second home purchasers, require a mortgage to finance the home purchase. In addition, many first and second home purchasers also require private mortgage insurance as a condition of receiving the necessary financing to complete the purchase. All of these factors help drive the home inspection business.

Currently, the home inspection business is random and does not provide a standardized inspection or reporting process. Home inspections and reports may vary depending on the inspector, the inspection company, the geographic region, the type of dwelling, etc. Individual home inspectors typically perform home inspections and report their findings in a manner that is opinionated and subjective. Accordingly, it is difficult, if not impossible, to compare and use home inspections to compare one property to other properties.

What is needed is a home inspection process and report format that brings order to the chaos that currently exists in the home inspection industry. Also, what is needed is a home inspection process and report format that is objective and analytical and that provides a uniform, national home rating system.

Also, home inspections currently performed just prior to the time of sale (i.e., after an offer has been accepted but prior to closing) and is typically a condition to the contract; generally creating contention for the concerned parties. The home inspection report is generally obtained by and utilized by the buyer, and not the seller or other parties involved in the sale of a home.

What is needed is a home inspection process and report format that may be performed early in the home sale and that may be used by all parties, to improve the home sale process and experience for all parties involved in the transaction.

The real estate market is enormous and growing larger. The home inspection business is here to stay. Growth in profit margins is proven by the increasing home inspection fees. The risk in this venture is that of development. At this time, the home inspection market is relatively flat and, more importantly, it is a cottage industry.

An analogy that may be used to illustrate this point is the car rental business. In the car rental business, Avis, a Detroit Ford dealer, came up with the idea of renting cars from the airport. He went no further than Detroit with that business. Hertz recognized the opportunity and seized upon it. He formed a partnership with General Motors. He formalized a cottage industry making Hertz #1 in the car rental business nationally (and internationally). The present invention seeks to do the same thing with home inspections.

### SUMMARY OF THE INVENTION

The following is a simplified summary of the invention in order to provide a basic understanding of some of the aspects of the invention. This summary is not intended to identify key or critical elements of the invention or to define the scope of the invention.

According to one embodiment of the invention, systems and methods for predictive asset ranking of property includes a database for receiving and storing attribute data for components of the property. A processor may access the database and apply multiple analytical hierarchies to the component attribute data. A component ranking may be generated by the processor for each component of the property. The component ranking is indicative of an overall condition of each of the property components. An overall ranking may be generated by the processor comprising an aggregate of the component rankings. The overall ranking is indicative of an overall condition of the property. The overall ranking may be used as a benchmark to compare the property to other properties. As such, the overall property ranking may be used as a predictive asset ranking tool in one or more facets of a transaction involving a property. An output system may be used to produce the overall ranking of the property to a user.

According to one aspect of the invention, the processor applies multiple analytical hierarchies to the component attributes in order to derive the component rankings. The hierarchies may be based on an efficient attribute weighing process that assigns a weighed ranking to each of the components based on responses to a series of questions relating to the component attributes.

According to another aspect of the invention, the predictive asset ranking system/method may be dynamic and allows customization of the predictive asset ranking system through selection of components for inclusion in deriving an overall property ranking.

According to another aspect of the invention, component software modules may be provided having one or more levels of sub-component software modules. Each component and sub-component software module may include a series of standard qualitative questions describing attributes of the component or sub-component. Selection of a component may load the component software module for inclusion in deriving an overall property ranking, including all of the sub-components and qualitative questions under the selected component. Alternatively, non-selection or de-selection of a component causes the component software module not to be loaded or unloaded from the derivation of an overall property ranking, including all of the sub-components and qualitative questions under the non-selected or de-selected component.

According to yet another aspect of the invention, components may include major components and sub-components. The major components may be selected from the group comprising: site and landscape; hard surfaces; site drainage; roofing system; building envelop; insulation and ventilation; interior finishes; appliances; HVAC; plumbing systems; and electrical systems.

According to another aspect of the invention, the component ranking may include a numerical sub-value or sub-score that numerically quantifies a condition of each of the components of the property. The overall ranking may also include a numerical value or score that numerically quantifies a condition of the property. The numerical value or score may also include a numerical score range, wherein the higher the numerical score, the higher the ranking of the property, and the lower the numerical score, the lower the ranking of the property. In addition, the numerical score range may include sub-ranges including textual descriptions of conditions of the property.

According to another aspect of the invention, the overall ranking may include a quantitative score derived from a series of qualitative questions relating to the component attributes using an analytic hierarchy process. Each of the components may be assigned a maximum possible sub-value or sub-score such that an aggregate of the maximum possible numerical sub-value or sub-score is equal to a maximum possible numerical value or score for the property.

According to yet another aspect of the invention, each of the components may be assigned a weighed value used to determine a component ranking. An aggregate of the component scores may equal an overall property ranking that is possible for the property. In one embodiment, the analytical hierarchies comprise Pairwise analytical hierarchies.

According to another embodiment of the invention, a predictive asset ranking system is provided including a hierarchical progression. The hierarchical progression may include an overall ranking comprising an overall total of possible points for a property, the overall total of possible points to be distributed over a plurality of components of the property based on a comparison ranking model. The component ranking for each component may include an overall total of possible points for the component, the overall total of possible points for the component to be distributed over a plurality of first sub-components under each of the components, each of the components to be compared for relative importance to each of the other components based on an attributes weighing process and comparison ranking model. A first sub-component ranking for each first sub-component may include an overall total of possible points for the first sub-component, the overall total of possible points for the first sub-component to be distributed over a plurality of second sub-components of each of the first sub-components, each of the first sub-components to be compared for relative importance to each of the other first sub-components based on an attributes weighing process and comparison ranking model. A second sub-component score for each second sub-component may include an overall total of possible points for the second sub-component, the overall total of possible points for the second sub-component to be distributed over a plurality of third sub-components of each of the second sub-components, each of the second sub-components to be compared for relative importance to each of the other second sub-components based on an attributes weighing process and comparison ranking model.

The predictive asset ranking system and method may include: an estimated useful life (EUL); an estimated age; a remaining useful life (RUL); and a percent EUL depleted, wherein the EUL, the estimated age, the RUL, and the percent EUL depleted may contribute to the points that are assigned to each selected component having an EUL.

According to another aspect of the invention, the property is a single family residential home.

According to another aspect of the invention, the output may include a report comprising the component rankings of conditions of the components and the overall ranking of the property condition. The report may provide an assessment of present condition and needs of the property, as well as future repair and replacement needs of the property. Key data and data points from the report or system database may be mined, analyzed, packaged and sold to specific list markets to be used as a predictive tool in determining whether to take an action relating to the property.

According to another aspect of the invention, the overall property ranking may be used as a predictive asset ranking tool by one or more of: sellers, purchasers, realtors, brokers, advertisers, mortgage providers, mortgage insurance providers, hazard insurance providers, home warranty providers, real estate appraisers, and secondary markets.

According to one aspect of the invention, the timing of the inspection service is moved closer to the time of listing. In this way, the home inspection report may become the owner's disclosure statement. It may also relieve the broker of liability regarding the physical condition of the property. A home inspection completed at the time of listing may provide the homeowner knowledge of any deficiencies. Repairs made prior to marketing the home are generally less expensive for the seller, who also has the option to make repairs or offer the property in its “as-is” condition.

A prospective buyer may be presented with a standardized home inspection report acknowledging any deficiencies, prepared by an independent third party; this is analogous, for example, to a Car-Fax Report in the used car business. This method may indemnify the seller, the buyer, and the broker; thereby facilitating the sale price negotiation. A lender may be able to reach a decision very quickly based on the standardized results of the home inspection process. A lender typically relies on several factors when deciding whether to make an investment, including: the buyer's credit score, an appraisal, and the inspection report with the dwelling's rating score. Research has proven that, based on this concept, there is an existing overwhelming demand for a standardized home inspection service.

According to another aspect of the invention, the home inspection process assists in the development of a computer generated report and demonstrates a viability and practicality to potential buyers, joint venture partners or users who may expand the use of the report format nationally and eventually internationally.

Home inspection profitability may be realized by the provision of home inspection services. In addition, profitability may also be realized from the sale of the derivative data developed and accumulated from home inspections. Data may be utilized on a direct basis and/or may be sold generically.

Additional features and advantages of the invention will be made apparent from the following detailed description of illustrative embodiments that proceeds with reference to the accompanying drawings.

### BRIEF DESCRIPTION OF THE DRAWINGS

The invention is best understood from the following detailed description when read in connection with the accompanying drawing. For the purpose of illustrating the invention, there is shown in the drawings exemplary constructions of the invention; however, the invention is not limited to the specific methods and instrumentalities disclosed. Included in the drawing are the following Figures:

FIG. 1 shows an exemplary predictive asset ranking system;

FIG. 2 is an outline of an exemplary hierarchical progression for one major component of a property being assessed;

FIG. 3 illustrates that resultant predictive asset ranking score may include a range, including a numerical range, and corresponding textual description of the condition of the property;

FIG. 4 is a flowchart illustrating an exemplary predictive asset ranking process;

FIG. 5 is a schematic diagram illustrating information flow for an exemplary predictive asset ranking system;

FIGS. 6A-6H are tables showing exemplary overall components, component weighed values, total available points, and points per Pairwise;

FIGS. 7A-7D show an exemplary analytical hierarchy calculation for determining weighed values for various components and sub-components;

FIG. 8 is an exemplary table of contents for a predictive asset ranking report

FIG. 9 shows exemplary pages from a predictive asset ranking report; and

FIG. 10 is a table illustrating the behind the scenes data points for a property.

### DETAILED DESCRIPTION OF ILLUSTRATIVE EMBODIMENTS

The following description is of several exemplary embodiments of systems and methods for predictive asset ranking of property. The systems and methods also provide for the development of reports, preferably computer generated reports, that may be used by sellers, potential buyers, joint venture partners, other service providers, and the like, in assessing the present condition and needs of a property, as well as future repair and/or replacement needs for the property. The data collected regarding the major components and subsystems associated with the property may be developed, accumulated and sold.

The illustrated embodiments are directed to the predictive asset ranking of real property, and in particular residential homes, but the invention is not necessarily limited to the evaluation of real property and/or residential homes. For example, it is contemplated that the present invention may also be applicable to other types of real property, such as commercial properties, and also others types of real property, such as automobiles, manufactured homes, recreational vehicles and the like.

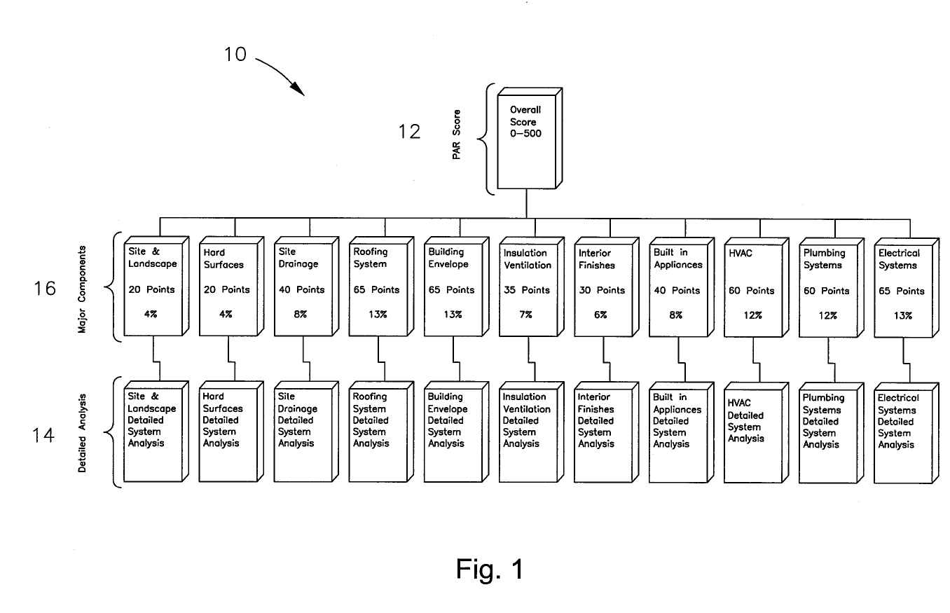

FIG. 1 illustrates the basic methodology that may be employed by an exemplary Predictive Asset Ranking (PAR™) system 10. The predictive asset ranking system/method (herein after also referred to as “PAR™ system” or “PAR™ method”) is a real property data collection process that quantifies the condition of key major components in a single family residential home and provides an asset ranking 12. In one embodiment, numerically quantifies the condition of the components of a home and provides the user a numerical ranking 12 (herein after also referred to as a “Home Score™”, “Home Value™”, “PAR Score™”, or “PAR Value™”). The numerical ranking 12 may include a value or score that is representative of individual components of the home and/or the overall condition of the home.

The predictive asset ranking process utilizes a series of questions pertaining to selected major components 14 of, for example, a single family residential home. The detailed analysis 14 collects data and information for various attributes of the components/sub-components being evaluated. Attributes include, for example, characteristics and/or qualities that may be inherent in, assigned to and/or ascribed to a component/sub-component. The response to the line of qualitative questioning may be converted to a quantitative score 16 by using, for example, an Analytic Hierarchy Process (AHP). Exemplary major systems/components that may be analyzed include: Site and Landscaping; Hardscape or Hard Surfaces; Site Drainage; Roofing; Structure; Building Envelope; Interiors; Heating Ventilation and Air Conditioning; Plumbing; Electrical; and the like.

Predictive asset ranking numerical ranking or scoring may be based on a mathematical formula which applies multiple analytical hierarchies to the various attributes of a residential home. The hierarchies may be based on an efficient attribute weighting process of, for example, Pairwise comparisons (also known as Pair-all). Pairwise comparison generally refers to any process of comparing entities in pairs to judge which of each pair is preferred, or has a greater amount of some quantitative property. The method of Pairwise comparison may be used, for example, in the scientific study of preferences, attitudes, voting systems, social choice, public choice, and multi-tangential systems.

Using a series of very specific questions related to attributes and performance of selected major components/systems 14, the process ultimately assigns a weighted numerical point value or score 16 to each major system within the single family residence. The calculated point value of each major system may then aggregate to provide an overall numerical score 12. The resultant numerical ranking or Home Score™ 12 may then be used as a benchmark to compare one residential home to another in the same manner, for example, the FICO Credit Score allows one individual's credit standing to be compared to another in determining relative credit worthiness.

The property numerical ranking or Home Score™ may help various users determine a relative characteristic worthiness for the property being assessed. For example, the property numerical ranking may be used by a mortgage company to determine a relative credit worthiness, a mortgage insurance company to determine a relative credit worthiness, an escrow company to determine a relative risk worthiness, an insurance company to determine a relative insurability worthiness, and the like.

The property ranking formulation allows the predictive asset ranking system, which in the illustrated embodiment is designed for the evaluation of any single family residence, to be customized to evaluate a specific type of single family residence. The formula driving the property ranking may be dynamic and portable so that the evaluator performing the asset evaluation using the predictive asset ranking process starts with, for example, a static, touch screen, computer based document that becomes dynamic as the evaluation of the asset proceeds. The evaluation may commence with the evaluator selecting the applicable components that will be included in the evaluation and used in the generation of the home ranking. The response of the evaluator to a series of questions may allow for the dynamic recalculation of the algorithm as the evaluation process is performed.

For example, if one is evaluating a condominium unit in a high rise setting, the sections of the predictive asset ranking process and report pertaining to Landscaping and Site, Roofing, Hardscape and Site Drainage would be “non-applicable” since typically the condominium association is responsible for the repair and replacement of these building components and not the individual condominium unit owner. If a component is selected as “non-applicable” the algorithm may be automatically recalculated and the points associated with the “non-applicable” component(s) may be redistributed over the components that are applicable to the asset. The manner in which the points are redistributed is preferably consistent with the formulation used in weighting all of the components and their sub-components.

One principle behind the predictive asset ranking algorithm may be based on the systematic comparison of one major component against another utilizing, for example, Pairwise analysis. This exemplary approach sets up a matrix that compares one component to another in overall importance to the assets' major components. This process moves in a hierarchical progression from the top down, and when completed, may compare thousands of different data points.

The predictive asset ranking process is preferably flexible and scalable. As such, the predictive asset ranking process may allow for the inclusion and/or exclusion of various components/systems in the evaluation and ranking process. Examples of other home components/systems that may be included in the predictive asset ranking process include: security systems, entertainment systems, appliances, swimming pool/spa/sauna/hot tub, accessory buildings, retaining walls, termites/wood destroying organisms, septic system, wells/water testing, sea walls, microbial/radon/asbestos/lead paint testing, lawn irrigation systems, building code violations, central vacuum, toxic or flammable conditions, and the like. A risk management assessment may be used to determine what systems/components to include in the predictive asset ranking assessment and report and some of these systems may require additional technical expertise.

The predictive asset ranking system and method may also include an optional feature for regional adjustments. Regional adjustment is a factor that may be built into the report algorithm and may be used to equalize or account for factors that may impact an asset in one region (i.e., location or region) of the country as compared to another region. Factors may include variables such as environmental and weather factors. The regional adjustment factor further allows for the national (or international) use of a common reporting format. The following are examples of regions that may be used in a regional adjustment: Northeast (severe winter, mild summer, soft water, moderate rainfall, freeze/thaw cycle); Mid Atlantic (hot summer, moderate winter, moderate rainfall, freeze/thaw cycle); South Atlantic (hot summer, mild winter, heavy rain fall, high humidity, coastal storms, hard water); Gulf Coast (very mild winter, severe storms, high humidity, high rainfall, hard water); Upper Midwest; Midwest; lower Midwest; Upper Mountain; Lower Mountain; Desert Southwest; Upper Pacific; Mid Pacific; Lower Pacific.

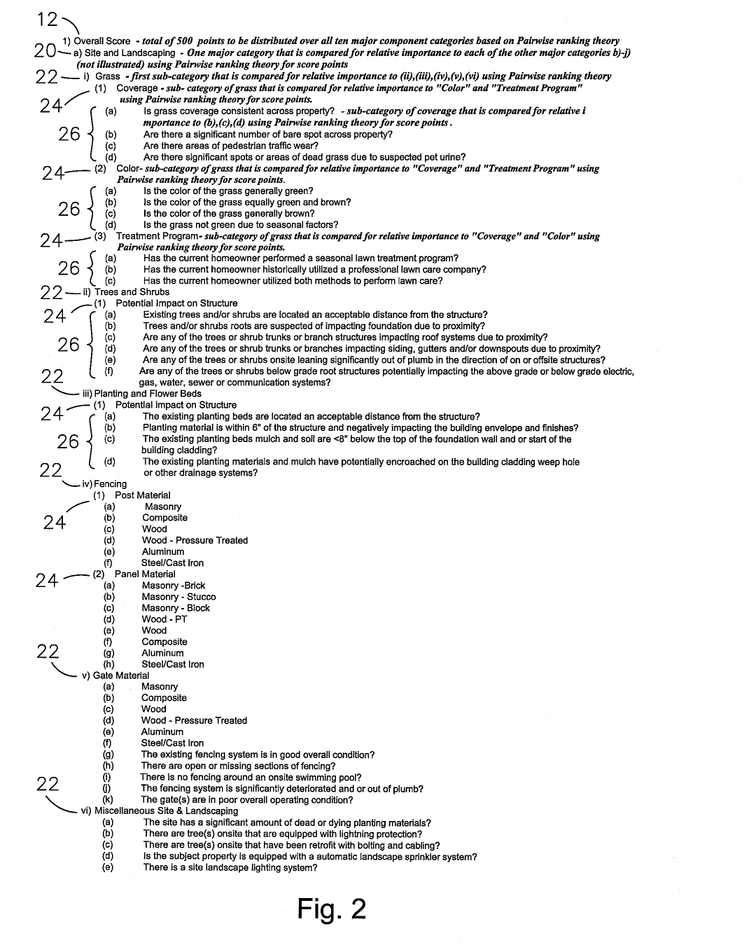

FIG. 2 is an outline of an exemplary hierarchical progression of one major component (Site & Landscaping) of a property being assessed. An overall score 12 may have a total numerical value (as shown 500 points) and the total point for the property being evaluated may be distributed over n major components categories, where n is the number of major components selected for inclusion in the predictive asset ranking process. The Site & Landscaping component 20 is further broken down in first sub-components 22 including, for example, i) grass, ii) trees and shrubs, iii) planting and flower beds, iv) fencing, v) gate materials, vi) miscellaneous site and landscaping, and the like. Each of the first sub-components 22 may be compared for relative importance to the other first sub-components using, for example, Pairwise ranking theory. For example, first sub-component i) grass shown in FIG. 2 may be compared for relative importance to ii) trees and shrubs, iii) planting and flower beds, iv) fencing, v) gate material, and vi) miscellaneous site & landscaping.

Each first sub-component 22 may include a number of second sub-components 24. For example, the first sub-component 22 for grass may include second sub-components 24 of (1) coverage, (2) color, and (3) treatment program. Each of the second sub-components 24 may be compared for relative importance to the other second sub-components 24 under a particular first sub-component 22 using, for example, Pairwise ranking theory for score points. For example, the second sub-component 24 of (1) coverage under the first sub-component 22 of i) grass shown in FIG. 2 may be compared for relative importance to (2) color and (3) treatment program.

Each second sub-component 24 may include a number of third sub-components 26. For example, the second sub-component 24 of (1) coverage may include third sub-components 26 of (a) is grass coverage consistent across property?, (b) are there a significant number of bare spots across property?, (c) are there areas of pedestrian traffic wear?, (d) are the significant spots or areas of dead grass due to suspected pet urine?, and the like. Each of the third sub-components 26 may be compared for relative importance to the other third sub-components 26 under a particular second sub-component 24 using, for example, Pairwise ranking theory for score points. For example, the third sub-component 26 of (a) is grass coverage consistent across property? shown in FIG. 2 may be compared for relative importance to items (b), (c), and (d).

The predictive asset ranking system may include multiple first sub-components, multiple second sub-components, multiple third sub-components, etc. and each of the levels (e.g., first, second, third, etc.) of sub-components may include questions relating to attributes of the property being evaluated. The questions and attributes may or may not be applicable for any given property. If the attribute is applicable, then the evaluator inputs data for the attribute. If the attribute is not applicable, the evaluator may input that the attribute is non-applicable or simply provide no input.

Key data and data points from the assessment and report may be mined, analyzed, packaged and sold to specific list markets. For example, mortgage companies and secondary lending markets may utilize the qualitative predictive asset ranking score as a predictive tool in determining if a marginal borrower is able to afford the upkeep on a low ranking property, thus avoiding significant numbers of foreclosures and loan workouts. Lawn service companies may use data to target marketing to property having low scores for site and landscape. Buyers and/or mortgage companies may use the data to determine whether to require a repair/replacement escrow account as part of the underwriting process. Banks may use the data to target properties that may require a home equity line of credit or home equity loan for making repairs/improvements. Pest control companies may use the data to target homes having low structural score indicative of possible pest problems.

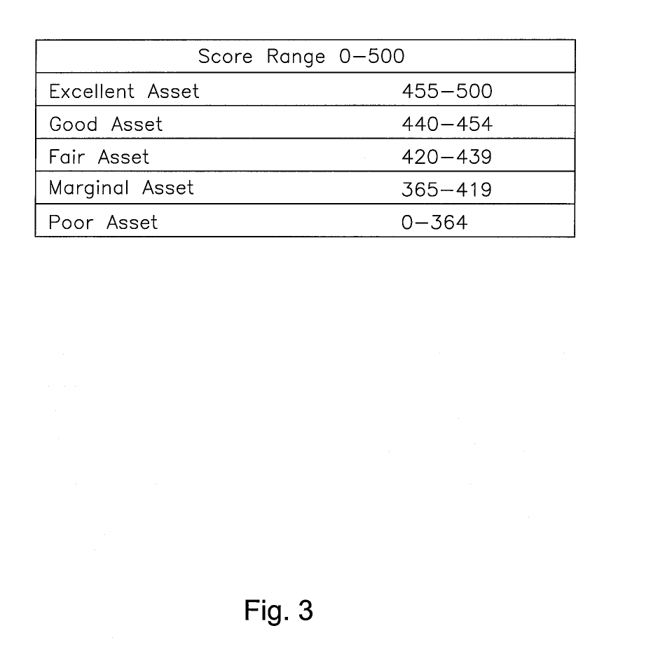

FIG. 3 illustrates that resultant predictive asset ranking or home score may include a range, including a numerical range, and corresponding textual description of the condition of the property. As shown in the example of FIG. 3, the predictive asset ranking score may range between 0-500 points and may include multiple descriptive categories such as: “poor asset” (0-364 points), “marginal asset” (365-419 points), “fair asset” (420-439 points), “good asset” (440-454 points), and “excellent asset” (455-500 points). The predictive asset ranking range or scale (i.e., content or display) is not meant to be limiting and may include any numerical, letter, alphanumeric, color-coded, character, symbolic, etc. system that may convey the present and future conditions and needs of a property, and that may be used as a benchmark in comparing one property to other properties.

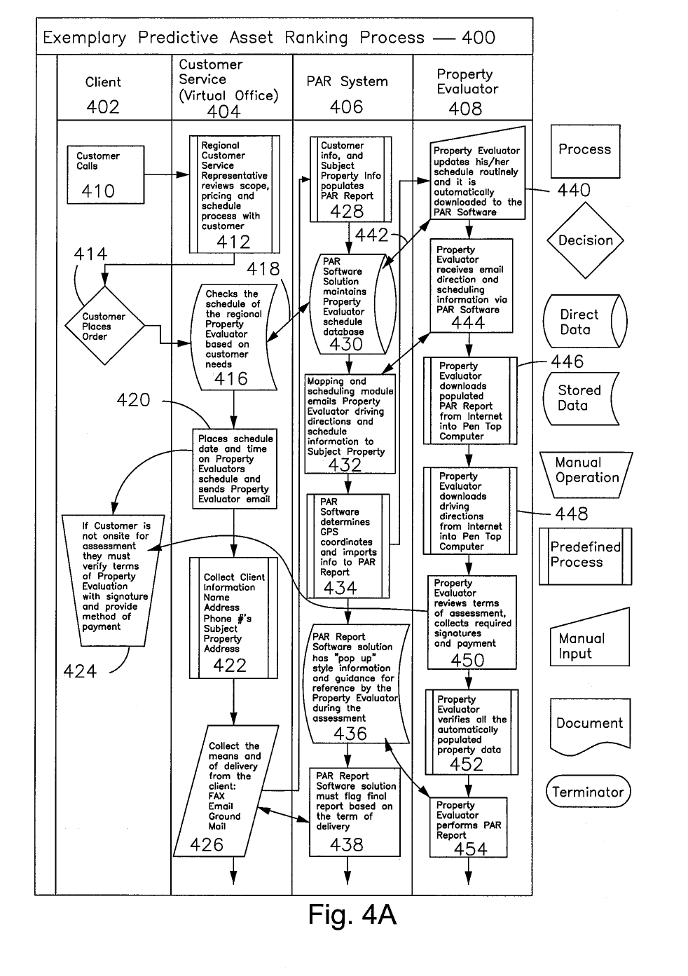

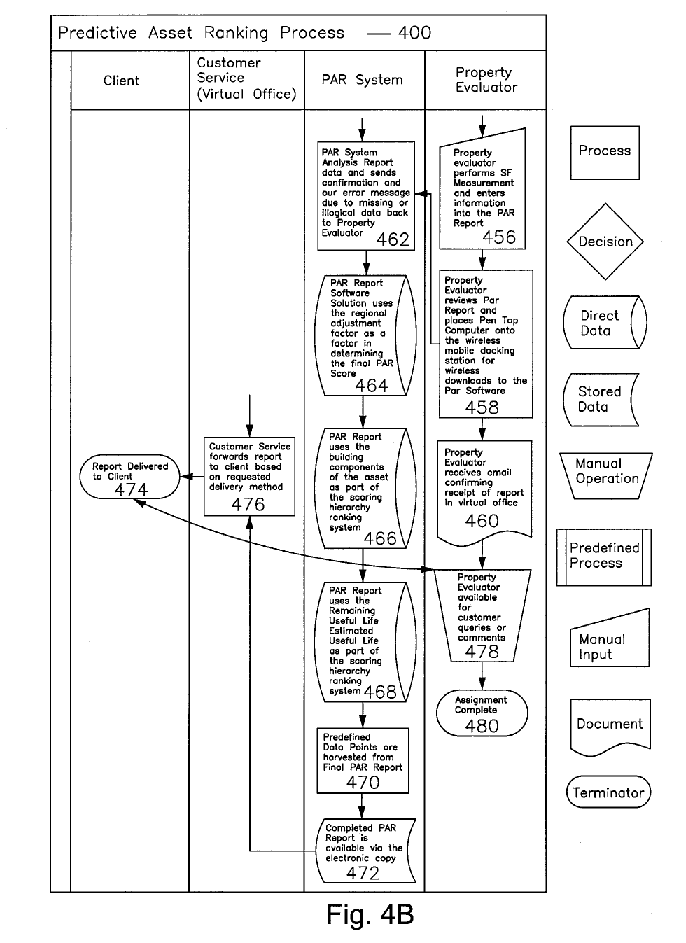

FIG. 4 is a flowchart illustrating an exemplary predictive asset ranking process. As shown in FIG. 4, the process 400 may be categorized into several general categories, including client 402, customer service 404 (e.g., a center office, regional office, virtual office, etc.), the predictive asset ranking system 406, and property evaluator/inspector 408. As show, the process 400 begins with a potential customer contacting a customer service center to inquiry about a home inspection (step 410). The customer interaction may occur via any communication means, such as in-person, telephone, facsimile, Internet, and the like.

A customer service representative receives the home inspection inquiry (step 412) and may review the scope, pricing, schedule, etc., with the customer. In one embodiment, the customer service may include virtual customer service offices set-up to cover geographic regions and service numerous property evaluators within a given geographic region. The virtual customer service may act as a key to help drive property evaluator productivity. The customer may then place an order for a home inspection (step 414). The customer service representative may then check the schedule of the regional property evaluator(s) based on the customer needs and preferences (step 416). The process may allow the customer service representative to access the predictive asset ranking system in order to check the property evaluator schedule database (step 418).

The customer representative may then schedule a date for the home inspection and send a notification to the customer and the property evaluator (step 420). The customer service representative may collect the customer's information (e.g., name, address, phone number, the address of the property to be assessed, etc.) (step 422). The customer may or may not be present during the home inspection. If the customer will not be on-site at the assessment, the customer may be required to verify the terms of the property evaluation and provide a method of payment in advance of the actual evaluation (step 424). The customer service representative may also collect from the customer the desired method of delivery of the predictive asset ranking report (step 426).

The customer information and information on the subject property may be received into the predictive asset ranking system (step 428). In one embodiment, the information may automatically populate the predictive asset ranking report. The predictive asset ranking software solution may maintain a property evaluator schedule database, which may be assessed to schedule, or verify the schedule of the evaluation (step 430). A mapping and scheduling module may generate directions, scheduling, and other information about the property and evaluation (step 432).

In one embodiment, the predictive asset ranking system 406 may include predictive asset ranking software that may be used to determine GPS coordinates that may be imported onto the predictive asset ranking report (step 434). The GPS coordinates may become the customer number, project number, property identifier, and the like. The predictive asset ranking system may also include a predictive asset ranking report software solution that provides interactive, pop-up style information and guidance for reference and ease-of-use by the property evaluator during the inspection and assessment (step 436). The predictive asset ranking system may include help pop-ups that may include details, photographs, identification aid photos, how to, reference materials, etc., to aid the property evaluator during the course of the assessment. The predictive asset ranking report software solution preferably flags the final report based on the terms of delivery specified by the customer (step 438).

The property evaluator/inspector 408 may update his or her schedule on a regular basis (step 440) and the schedule may be automatically downloaded to the predictive asset ranking software (step 442). The day to day and hour to hour scheduling is the responsibility of the property evaluator and should include vacations, days off, hours off, etc., so that the predictive asset ranking system scheduling module, and the customer service team, will not schedule an evaluator for times that are blocked out and would logically move to the next property evaluator in the queue for that assignment. The property evaluator may receive notification, directions, scheduling, and other information about the property and evaluation via the predictive asset ranking system (step 444).

In one embodiment, the property evaluator may download a populated predictive asset ranking report from, for example, the Internet into a portable electronic device, such as a Pen Top computer (step 446). The property evaluator may also download driving directions to the portable electronic device (step 448). Preferably, the predictive asset ranking system includes a check and balance system to assure that the property evaluator is in good standing (e.g., current with all training, certifications, licensing, past assignments, payments, etc.) with the predictive asset ranking service provider. The property evaluator may review the terms and conditions of the assessment and may collect the necessary authorization and payment from the customer (step 450). In one embodiment, the predictive asset ranking system may include a digital signature feature to allow for client signature on-site, as well as client credit card and check debit capability. Preferably, the property evaluator verifies all of the automatically populated data and information (step 452).

The property evaluator performs the property inspection/assessment and completes the predictive asset ranking report (step 454). The property evaluator may perform square feet or cubic feet measurements and enters information into the predictive asset ranking report (step 456). These measurements may be used, for example, by HVAC companies, painters, flooring/carpeting companies, etc. The property evaluator reviews the draft predictive asset ranking report and may input the report to the predictive asset ranking system (step 458). For example, the property evaluator may place the Pen Top computer onto a wireless mobile docketing station for wireless transmission to the predictive asset ranking software. The property evaluator may receive a notification confirming receipt of the predictive asset ranking report into the predictive asset ranking system (step 460).

The predictive asset ranking system may analyze the report data and information (step 462). This review and analysis may include a confirmation of receipt of the report as well as an error message that is transmitted back to the property evaluator if any information is missing and/or illogical. The predictive asset ranking report software solution may use regional adjustment factors in determining the final predictive asset ranking of the property (e.g., a numerical value or score) (step 464).

The predictive asset ranking process and report may use the specific components/systems of the asset as part of the ranking/scoring hierarchy (step 466). The predictive asset ranking process and report may also use the Remaining Useful Life (RUL)/Estimated Useful Life (EUL) as part of the ranking/scoring hierarchy (step 468).

Data points, including predefined and/or random data points, may be harvested from the predictive asset ranking report (step 470). The completed predictive asset ranking report may be made available to the customer (step 472). The completed report may be delivered to the customer (step 474) in accordance with the report delivery methodology specified by the customer (see steps 426 and 438). This delivery may be accomplished through the customer service representative that may forward the report to the client based on the requested delivery method (step 476).

The property evaluator may be available to answer customer queries or comments (step 478). After responding to any customer queries, comments, or after a predetermined time has passed, the assignment is complete (step 480).

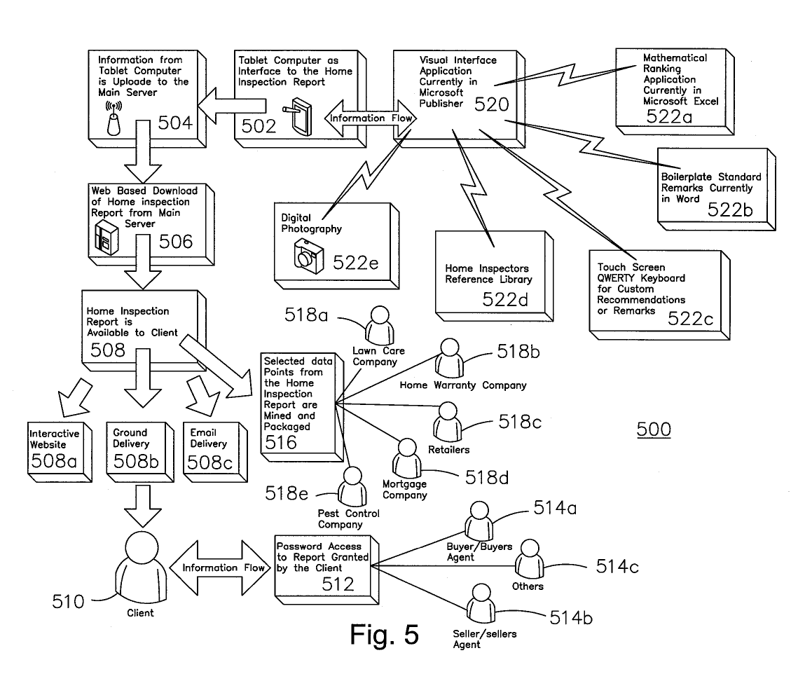

FIG. 5 is a schematic diagram illustrating information flow for an exemplary predictive asset ranking system 500. As shown in FIG. 5, a portable electronic device 502, such as a tablet computer, may be used to interface with the predictive asset ranking software and report. Information from the tablet computer may be uploaded to a server 504. The communication between various devices/components within the system may be by any conventional means, such as wired and wireless means. An interface 506, such as a web-based interface, may be provided to access and download the home inspection report from the server 504. A distribution/transmission means 508 may be used to make the home inspection report available to the client. The distribution/transmission means 508 may include, for example, an interactive Website 508a, ground delivery 508b, email delivery 508c, facsimile, or any other suitable means for conveying the home inspection report to the client 510.

The client may grant access to the home inspection report to various persons involved in the asset transaction. The accessing of the report by persons other then the client may be controlled by a password protected account 512. Examples of persons that may be granted access to the report include, but are not limited to: the buyer and the buyer's agent 514a, the seller and the seller's agent 514b, and others 514c involved in the sale of the asset.

Also, the information and data collected and contained within the predictive asset ranking report may be made available to other parties that are indirectly involved in the asset transaction. For example, an interface 516 may be provided to make selected data points and information from the asset inspection report available to outside vendors. Select data and information from the report and system database may be mined and packaged for sale and/or use by, for example, lawn care companies 518a, home warranty companies 518b, retailers 518c, mortgage companies 518d, pest control companies 518e, and the like.

Further, information may flow between the predictive asset ranking system and outside applications. For example, information regarding the home inspection and asset evaluation may flow from the tablet computer interface 502 and a visual interface application 520, such as, for example, the Microsoft Publisher visual interface application. Various applications may further interface with the predictive asset ranking system through the visual interface application 520 including, for example: a mathematical ranking application 522a, such as, for example, the one currently in Microsoft Excel; a boiler plate standard remarks application 522b, such as, for example, the one that currently exists in Microsoft Word; a touch Screen QWERTY keyboard for custom recommendations and/or remarks 522c; a home inspection reference library application 522d; a digital photography application 522e; and the like.

The following description and the accompanying drawings illustrate some of the details of analytical hierarchies that may be used with the present invention for predictive asset ranking of property. The examples provided use the Pairwise analytical hierarchy process, however, the invention is not limited to this particular analytical hierarchy process.

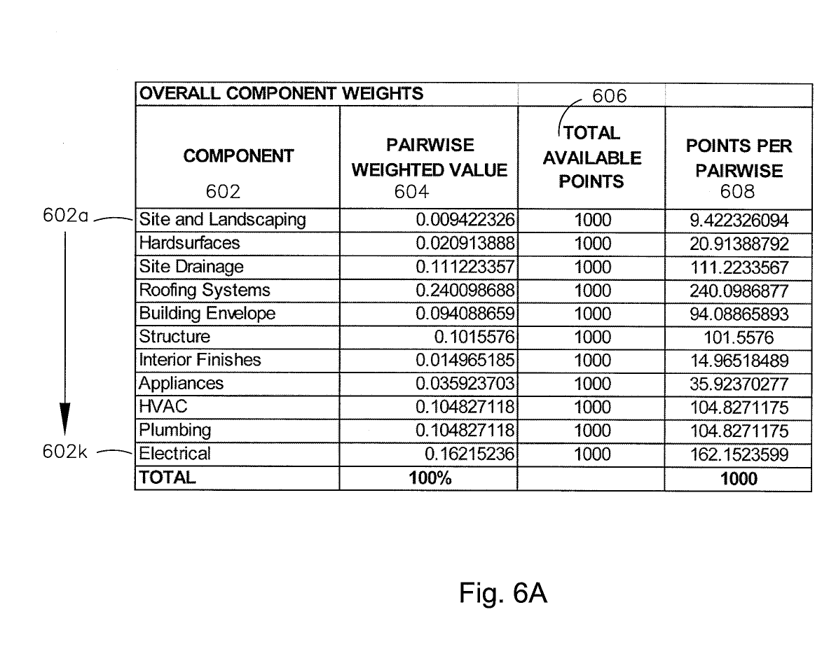

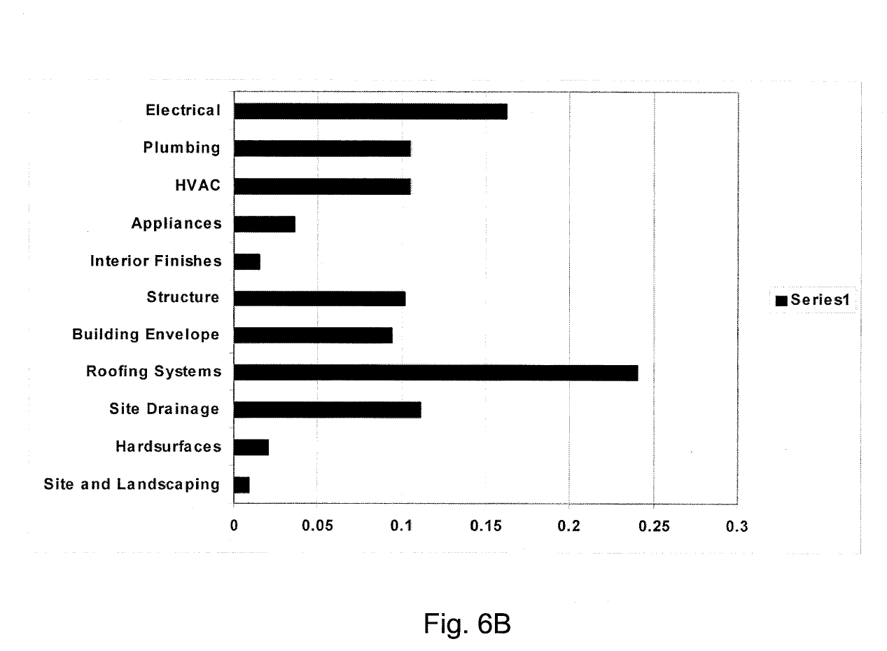

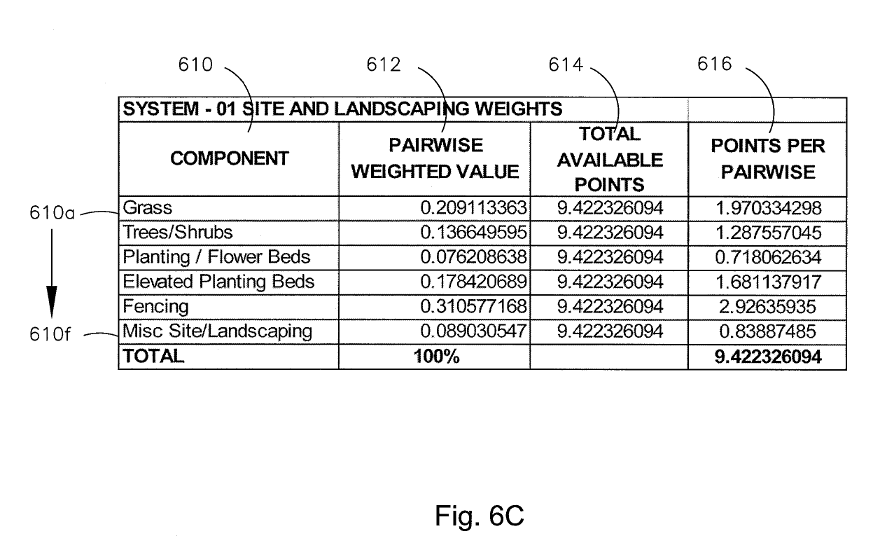

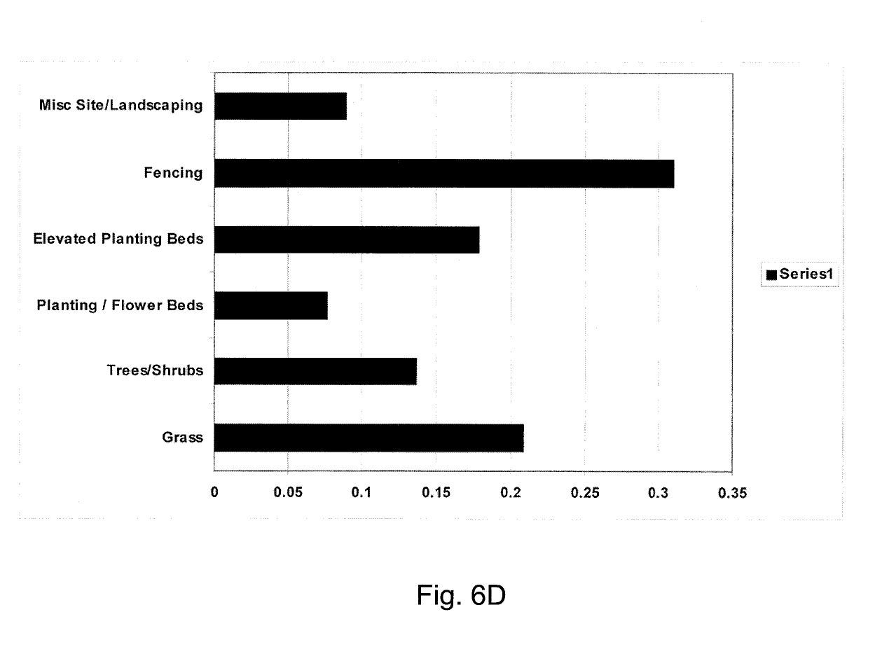

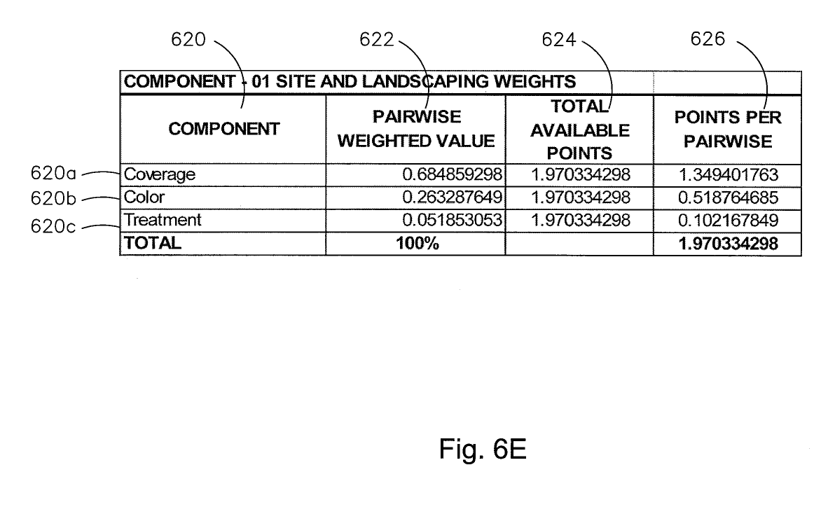

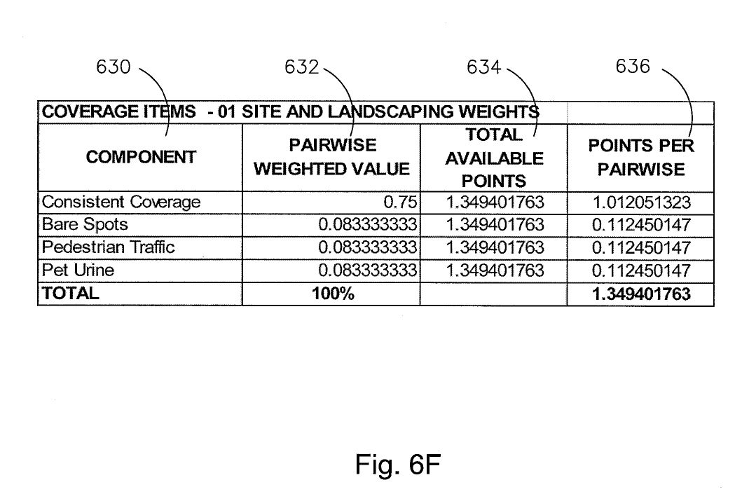

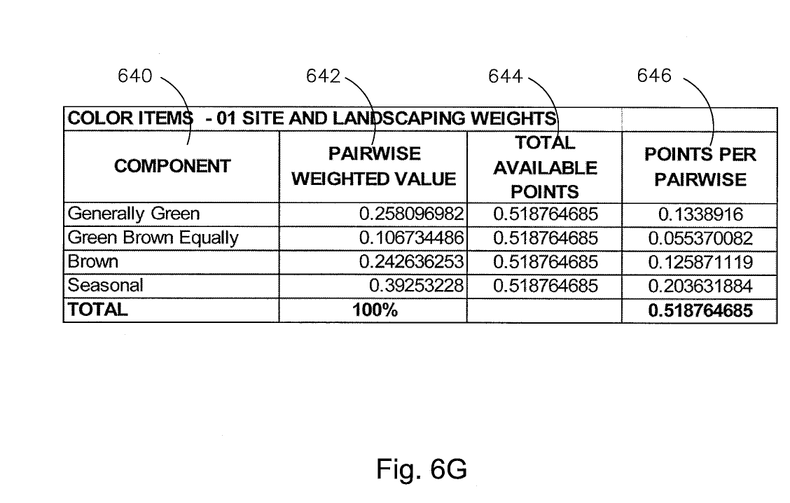

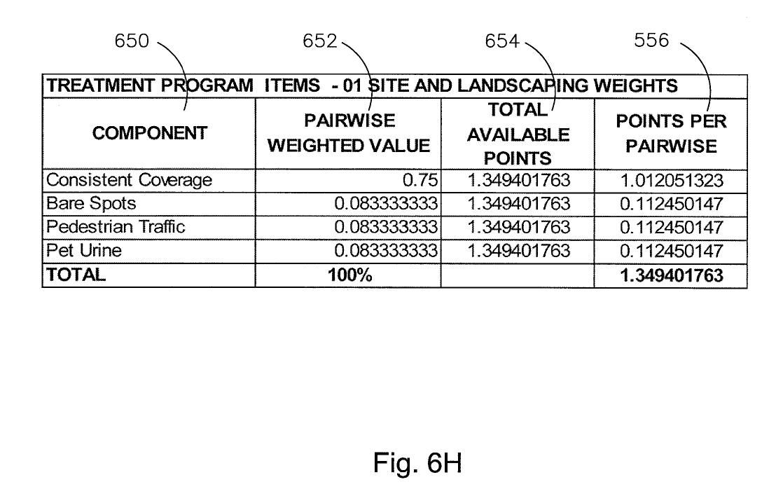

FIG. 6A is a table showing exemplary overall components 602, component weighed values 604, total available points 606, and points per Pairwise 608. The analytical hierarchy process is a top down process that uses a series of very detailed, qualitative questions that may be distributed over a plurality of sub-components (e.g., first sub-component through n^{th} sub-component). The components (e.g., key or major components) selected in the illustrated example include: site & landscape 602a; hard surfaces 602b; site drainage 602c; roofing systems 602d; building envelope 602e; structure 602f; interior finishes 602g; appliances 602h; HVAC 602i; plumbing 602j; and electrical 602k. As shown, the sum of all the selected components 602a-602k equals 100%, the total available points for each component equals 1000, and the total points per Pairwise for all the components equals 1000. FIG. 6B is a bar graph illustrating the Pairwise weighed value for each component listed in FIG. 6A.

FIG. 6C is a table showing exemplary first sub-components 610, first sub-component weighed values 612, total available points for each first sub-component 614, and points per Pairwise for each first sub-component 616. The first sub-components 610 selected in the illustrated example are first sub-components under the site & landscape component 602a and include: grass 610a; trees/shrubs 610b; planting/flower beds 610c; elevated planting beds 610d; fencing 610e; misc. site/landscaping 610f. FIG. 6D is a bar graph illustrating the Pairwise weighed value for each first sub-component listed in FIG. 6C.

FIG. 6E is a table showing exemplary second sub-components 620, second sub-component weighed values 622, total available points for each second sub-component 624, and points per Pairwise for each second sub-component 626. The second sub-components 620 selected in the illustrated example are second sub-components under the grass first sub-component 610a and include: coverage 620a; color 620b; and treatment 620c.

FIG. 6F is a table showing exemplary third sub-components 630, third sub-component weighed values 632, total available points for each third sub-component 634, and points per Pairwise for each third sub-component 636. The third sub-components 630 selected in the illustrated example are third sub-components under the coverage second sub-component 620a and include: consistent coverage 630a; bare spots 630b; pedestrian traffic 630c; and pet urine 630.

FIG. 6G is a table showing exemplary third sub-components 640, third sub-component weighed values 642, total available points for each third sub-component 644, and points per Pairwise for each third sub-component 646. The third sub-components 640 selected in the illustrated example are third sub-components under the color second sub-component 620b and include: generally green 640a; green brown equally 640b; brown 640c; and seasonal 640d.

FIG. 6H is a table showing exemplary third sub-components 650, third sub-component weighed values 652, total available points for each third sub-component 654, and points per Pairwise for each third sub-component 656. The third sub-components 650 selected in the illustrated example are third sub-components under the treatment second sub-component 620c and include: fertilizer 650a; pest control 650b; watering 650c; thatch 650d; and aerate 650e.

It should be noted that the level of detail and the number of sub-components may vary depending on the application and the asset being evaluated. The predictive asset ranking system preferably includes a plurality of components, each component preferably having a plurality of levels of sub-components (e.g., a plurality of first sub-components, second sub-components through n sub-components), and each sub-component having a plurality of qualitative questions that are descriptive of attributes of the asset being evaluated. The greater the number of components, sub-components, and questions, the more robust the predictive asset ranking system. Note that each of the other major components 602b-602k may have their own corresponding first sub-components; each of the other first sub-components may have their own corresponding second sub-components, etc.

Preferably, the predictive asset ranking system is flexible and scalable. As such, the system and process preferably allows an inspector/evaluator to select the components and/or sub-components that are applicable to a particular asset, and then the predictive asset ranking software may automatically populate the appropriate sub-components with relevant questions.

The predictive asset ranking system may include software for implementing the evaluation and assessment of a property. The software may be implemented, for example, in component software modules. Each component module may include one or more levels of sub-component software modules. Each component and sub-component software module may include a series of standard qualitative questions describing attributes of the component or sub-components.

The system may be customized for use in the assessment of a particular property. For example, the evaluator may select a component for inclusion in the property assessment. When a component is selected, the system may load the corresponding component software module for inclusion in the assessment and in the derivation of the overall property ranking. Each component software module may include all of the sub-components and qualitative questions for the selected component.

Alternatively, the system may be set up such that the evaluator either does not select or de-selects a component for inclusion in the assessment. The non-selection or de-selection may cause the component software module to either not be loaded or unloaded from the assessment and derivation of the overall property ranking. Again, this would include all of said sub-components and qualitative questions under the non-selected or de-selected component.

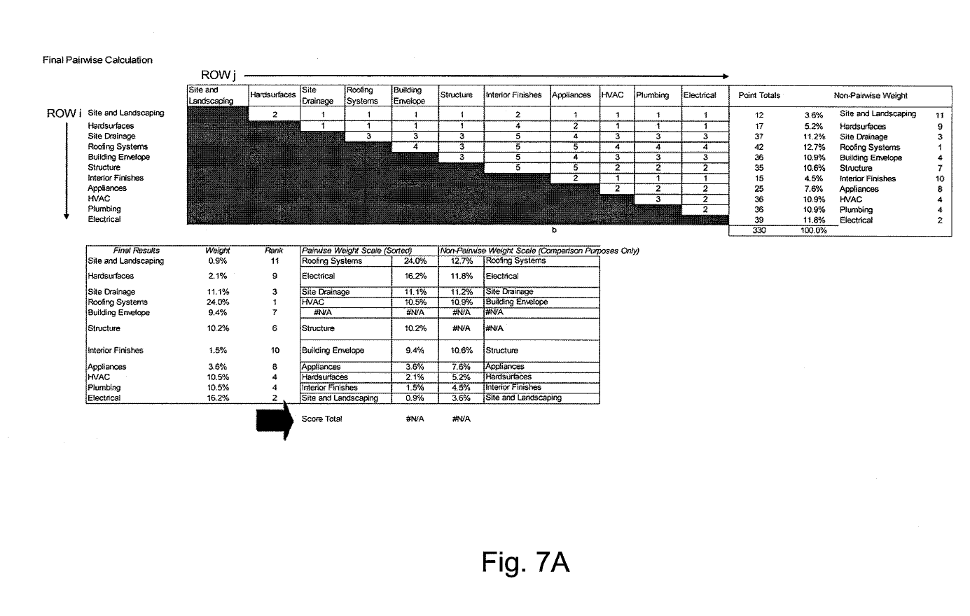

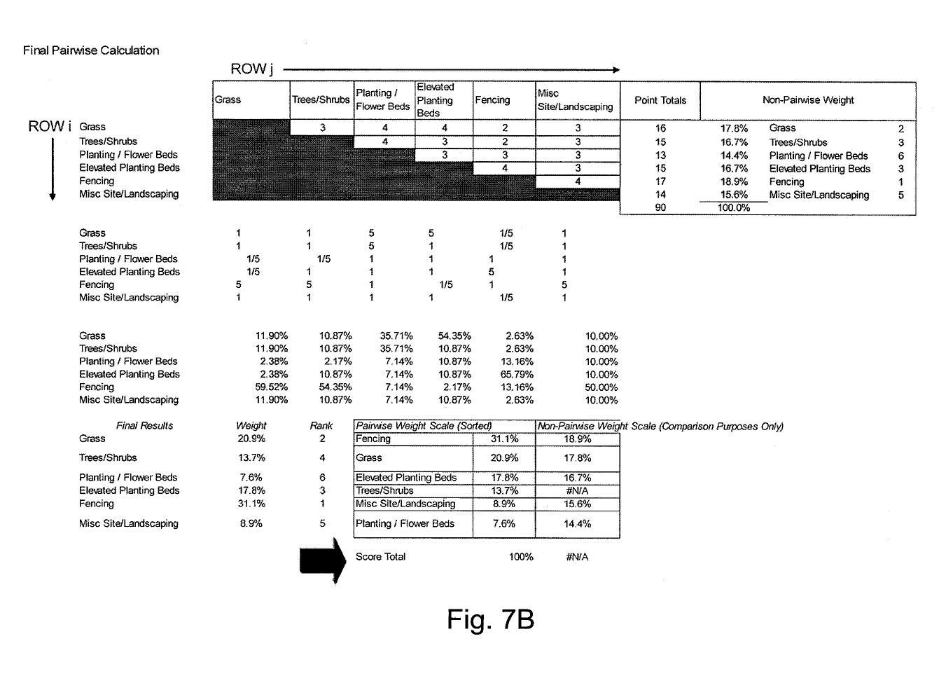

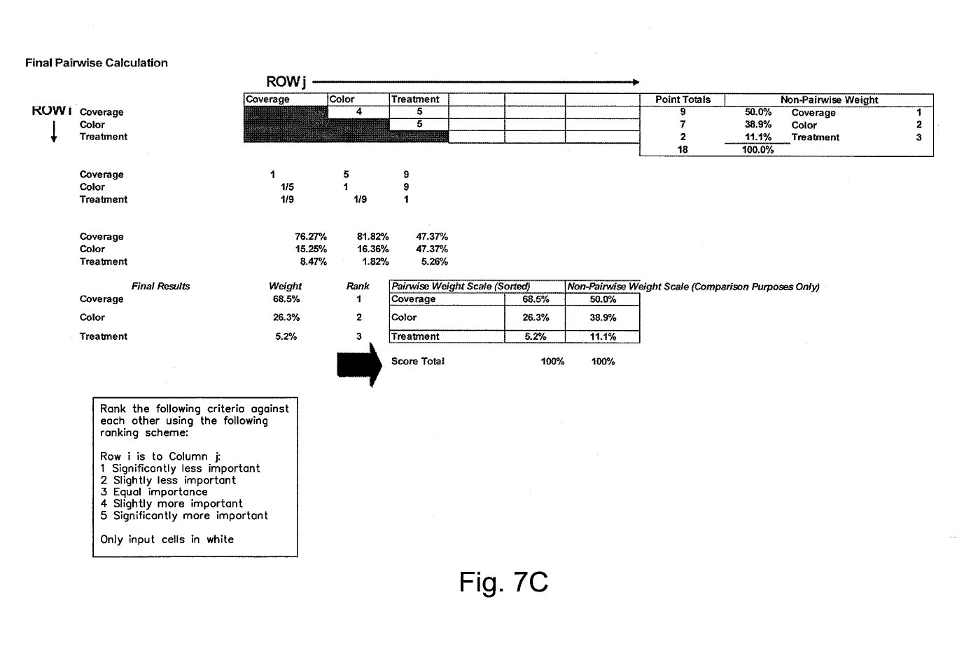

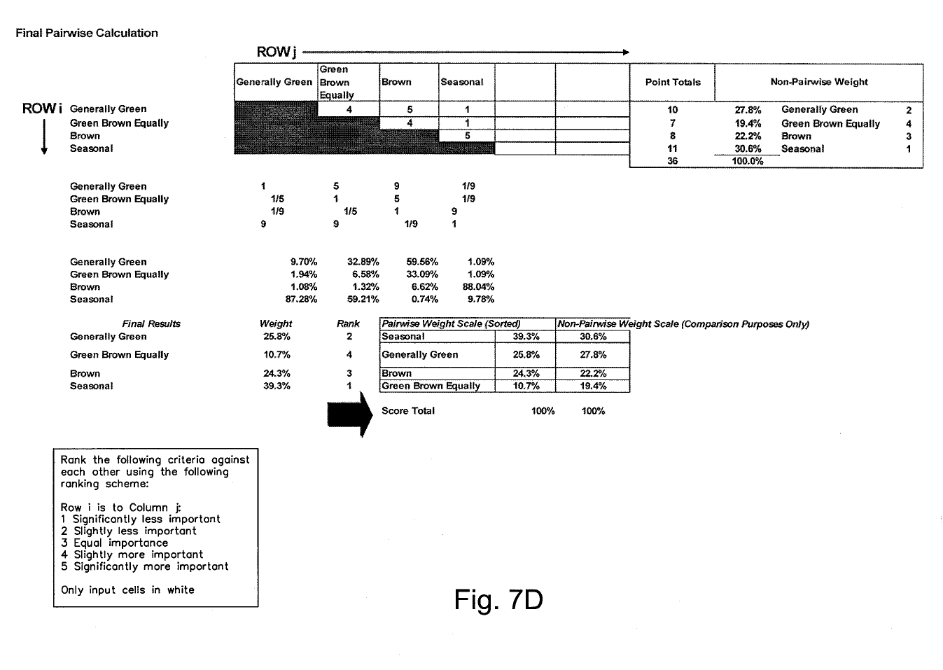

FIGS. 7A-7D show an exemplary analytical hierarchy calculation for determining weighed values for various components and sub-components. The ranking system weighs each component in a property in relation to the whole, with consideration being accorded to age in relation to life expectancy and overall condition. The overall ranking of the property is the sum total of the individual ranking of each component.

In the illustrated embodiment, a Pairwise process of analytical hierarchy is used. The predictive asset ranking system may employ other types of analytical hierarchy processes. The analytical hierarchy process may rank the listed criteria against each other using the following exemplary ranking scheme:

Row i is to column j:

1. significantly less important

2. slightly less important

3. equal importance

4. slightly more important

5. significantly more important

In FIGS. 7A-7D, the input cells are shown in white.

FIG. 7A shows an exemplary final Pairwise calculation comparing the site & landscaping component to each of the other selected components. FIG. 7B shows an exemplary final Pairwise calculation comparing the grass first sub-component to the other selected first sub-components under the site & landscaping component. FIG. 7C shows an exemplary final Pairwise calculation comparing the coverage second sub-component to the other second sub-components under the grass first sub-component. FIG. 7D shows an exemplary final Pairwise calculation comparing the generally green third sub-component to the other third sub-components under the color second sub-component. A similar comparison and weighing would be performed for all components and sub-components.

For an exemplary residential home sale, the weighed component scoring may appear as follows:

| Component | Weighted Component Scoring |
|---|---|
| Site & Landscape | 20 points or 4% of Overall Score |
| Hard Surfaces | 20 points or 4% of Overall Score |
| Site Drainage | 40 points or 8% of Overall Score |
| Roofing Systems | 65 points or 13% of Overall Score |
| Building Envelope | 65 points or 13% of Overall Score |
| Insulation/Ventilation | 35 points or 7% of Overall Score |
| Interior Finishes | 30 points or 6% of Overall Score |
| Appliances | 40 points or 8% of Overall Score |
| HVAC | 60 points or 12% of Overall Score |
| Plumbing Systems | 60 points or 12% of Overall Score |
| Electrical Systems | 65 points or 13% of Overall Score |
| Total | 500 Points 100% |

The weighted component scoring illustrated above is exemplary only and is not meant to be limiting.

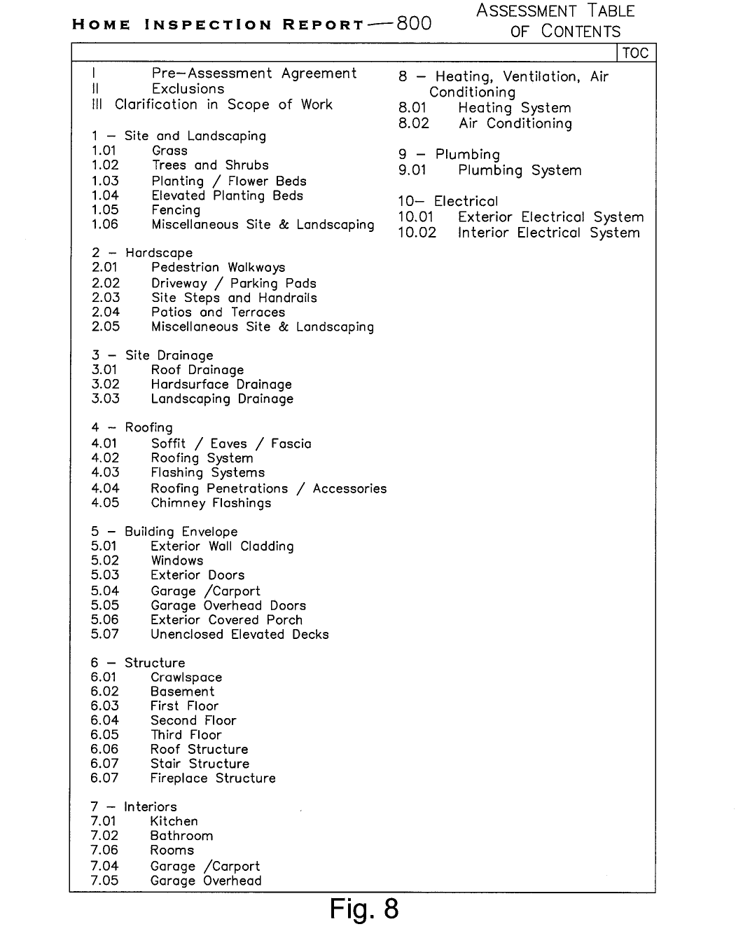

FIG. 8 shows an exemplary table of contents for a predictive asset ranking report 800. As shown, the report may include a section for each of the major components (e.g., sections 1-10), as well as sub-sections for each of the sub-components under each major component (e.g., sub-sections 1.01-1.06; 2.01-2.05; 3.01-3.03; 4.01-4.05; etc). The report may include the terms and conditions of the pre-assessment agreement, exclusions, a statement of the scope of work, etc. (e.g., preamble I-III). The exclusions may include, for example, items that may be hard to do or access, may require a specialty, or involve risk management. The predictive asset ranking report preferably includes an analytical and objective format and includes a depth of report that is inclusive, examining each pertinent attribute of a home that is evaluated on the basis of age-life, safety, quality, and condition.

The weighted averages of each component methodically develops a sum total over rating or home score. The predictive asset ranking process and report are preferably standardized and repeatable using the same criteria of judgment applied uniformly on a national (or international) basis. This process results in an accurate, precise, and comprehensive report that may be universally understood and used.

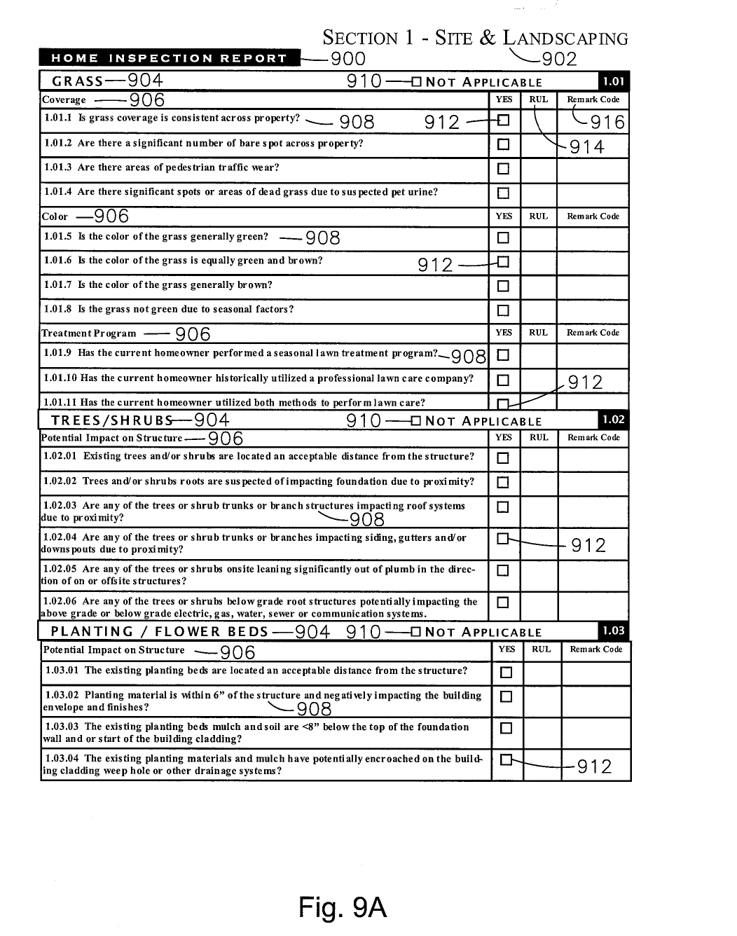

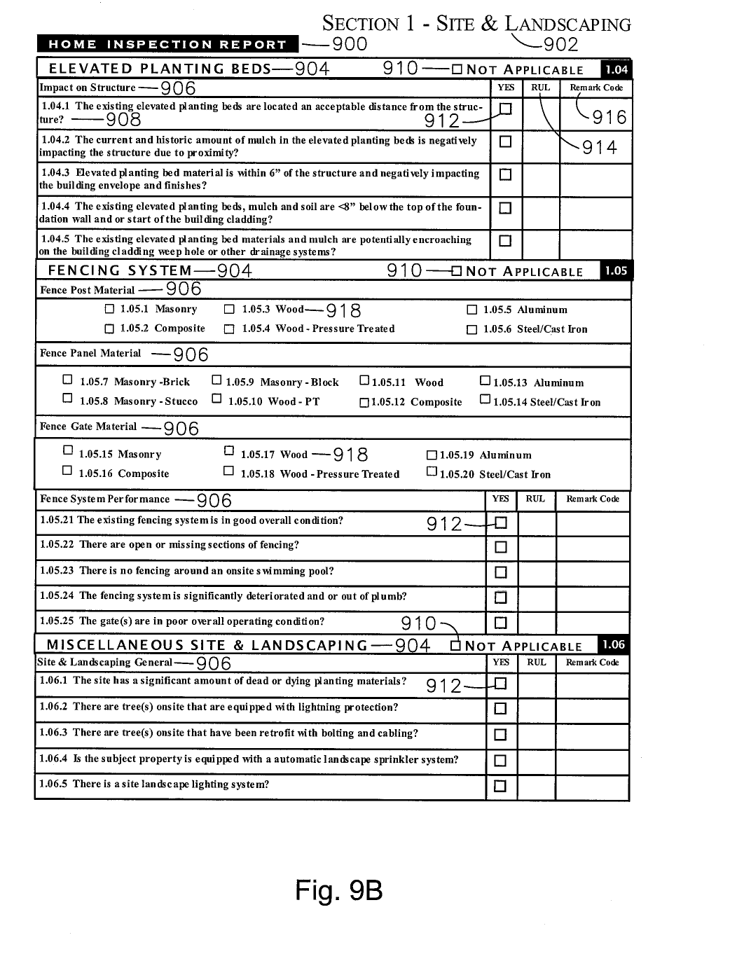

FIG. 9 shows exemplary pages from a predictive asset ranking report 900 for section 1—site & landscaping component 902. As shown, the report may include first sub-components 904 (e.g., grass; trees/shrubs; planting/flower beds; elevated planting beds; fencing system; misc. site & landscaping) (report sub-sections 1.01-1.06), second sub-components 906 (e.g., under grass: coverage; color; treatment program), and a plurality of qualitative questions regarding attributes of the property 908.

Preferably, the report provides the capability to indicate that a particular component (or sub-component) is not applicable 910. If the component is not selected for evaluation, then the predictive asset ranking system may dynamically recalculate the weight for the remaining/selected components. In the illustrated embodiment, each question may be designated yes if the attribute 912 is applicable. Having a single possible answer set up for an affirmative helps streamline the inspection process and saves on data points. The evaluator may also provide an estimate of the remaining useful life (RUL) 914. Remarks or notes may be included in a remark code section 916. The remark codes may include a drop down menu with standard statements that may be applicable or remarks may be manually entered. The report may also provide a list of possible attributes 918 for the evaluator to choose from. The report may also include a summary section for each component that may list continued inspections, corrective actions, forecasts of average maintenance costs, repair and replacement costs as well as estimated time to repair/replacement, and references.

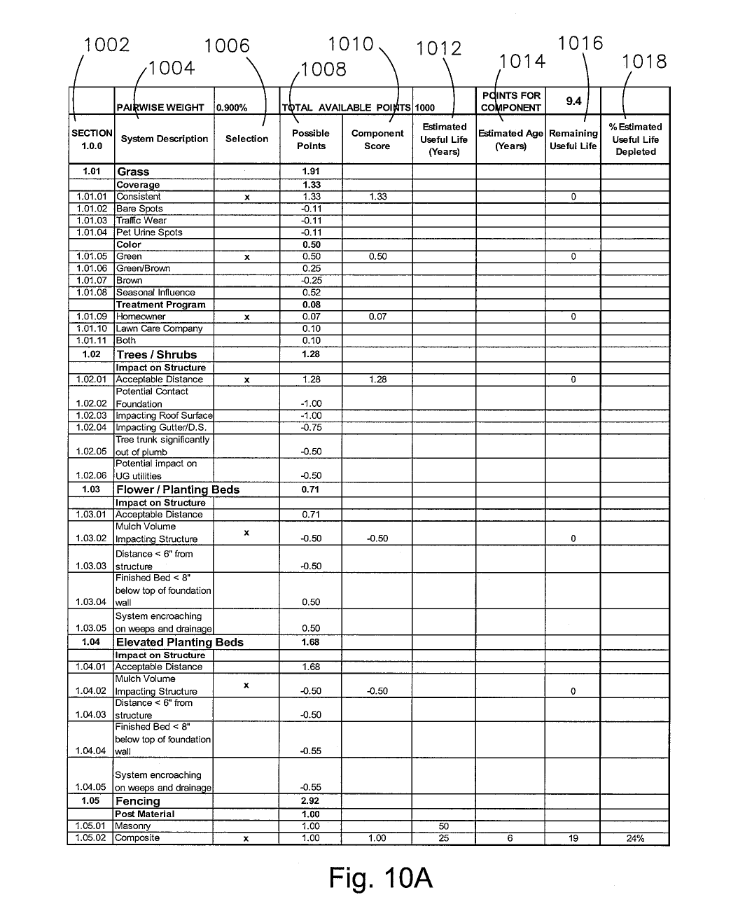

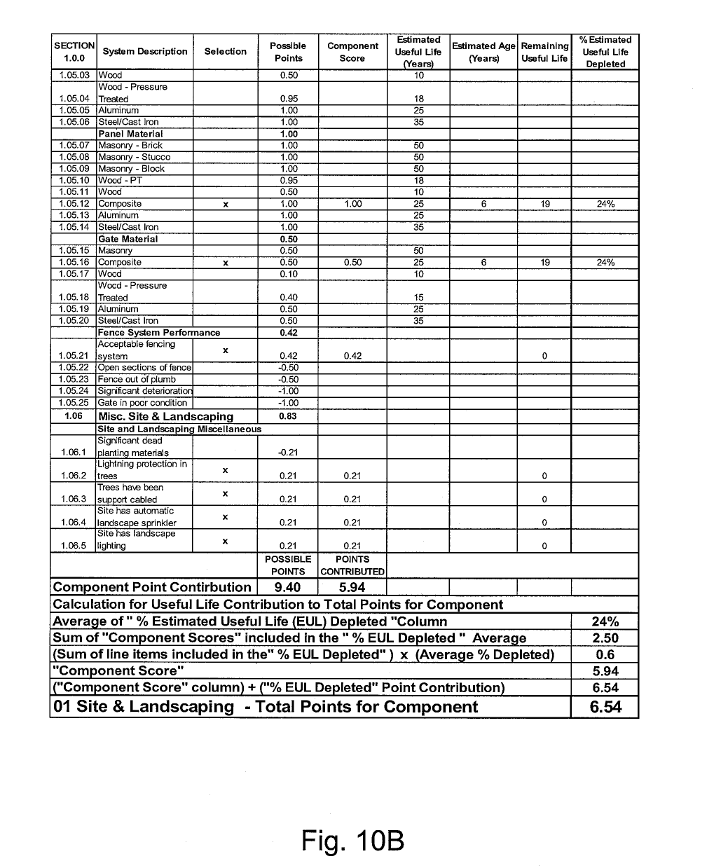

FIG. 10 is a table illustrating the behind the scenes data points that correspond to what the evaluator is doing and seeing in the field during the actual inspection of the property. These data points may be used to build a component score. As can be appreciated, the predictive asset ranking process includes a plurality of data points. Continuing with the exemplary embodiment being described, the site & landscaping component is shown with the collected data points populated in the field corresponding to the particular attribute being assessed. FIG. 10 shows a Pairwise weight of 0.900%, total available points of 1000, and actual points for the site & landscape component of 9.4.

As shown, the table 1000 may include a designation of the section and multiple sub-sections of the predictive asset ranking report 1002, a system description of the component, first sub-components, second sub-components, etc. 1004, selection indication 1006, the possible points 1008, the component/sub-component score 1010, the estimated useful life (EUL) 1012, the estimated age 1014, the remaining useful life (RUL) 1016, and the % EUL depleted 1018.

The table also shows the total aggregate component ranking (i.e., value or score). As shown, the exemplary site & landscape component included: 9.40 possible points; a component score of 5.94; an EUL of 6.00 years; an estimated age of 2.50 years; a RUL of 0.06; and an average % EUL depleted of 24%. The EUL may be obtained from historical data and/or peer review. The EUL may represent an adjusted score (“component score” column+% EUL depleted” point contribution). The estimated age is a sum of the line items in the % EUL depleted column. The RUL may be a sum of the line items included in the % depleted EUL column×average % of EUL depleted column.

Preferably, the system and method allow for weighing of the various major categories and sub-categories (see FIGS. 7A-7D). Using the aesthetic “curb appeal” mind set that is currently prevalent in the home purchase decision one may conclude that the landscaping and site amenities are very important; however, the failure of the landscaping and site amenities would not be of immediate monetary distress to the homeowner. Comparatively, the failure of the roofing system, however, may cause an immediate and considerable monetary burden to the homeowner. For example, research has shown that 90% percent of median to low income home buyers are two to three mortgage payments ($3,000-$4,500) away from foreclosure. The median to low income buyer makes up 60% of the home buying market. A roofing system failure could easily consume the two to three months worth of reserve that the typical low to median income home owner has on-hand, thus putting 60% of the housing market on the verge of losing a home to the foreclosure process. This scenario demonstrates one of many important reasons why the predictive asset ranking model for the evaluation and inspection of real estate assets is revolutionary.

RealtyTrac™ (www.realtytrac.com)—the leading online marketplace for foreclosure properties—published their 2006 QI U.S. Foreclosure Market Report, which showed that 323,102 properties nationwide entered some stage of foreclosure in the first quarter of 2006, a 38 percent increase from the previous quarter and a 72 percent year-over-year increase from the first quarter of 2005. The nation's quarterly foreclosure rate of one new foreclosure for every 358 U.S. households was higher than in any quarter of last year. Many lenders are responding to this trend by creating more and riskier ways for a purchaser to finance a home; such as 40 year mortgages, interest only loans, low introductory interest rate and adjustable rate mortgages (ARM). The use of the predictive asset ranking system may assist in predicting if the condition of the asset puts it at risk for foreclosure in the same way that, for example, the Fair Isaacs Company (FICO Score) attempts to predict if the credit history of a buyer puts them at risk for default.

RealtyTrac™ further estimates that 595,211 households entered some stage of the foreclosure process in the first half of 2006. If this trend continues, 1,190,422 homes will potentially be lost to the foreclosure process in 2006. The National Association of Realtors (NAR) estimates that the median single family home price for the first three quarters of 2006 is $277,000. This would extrapolate into approximately 329 billion dollars of real estate in foreclosures. According to published information, the average foreclosure costs the mortgage industry $59,0002. This would extrapolate into approximately 70 billion dollars of potential loses to the mortgage industry due to foreclosures. If the predictive asset ranking system had been used in 2006 and was able to mitigate only 2% of foreclosures, this would result in a reduction of loss to the lending industry, and all affiliated parties, of approximately 1.5 billion dollars.

Another revolutionary benefit of the predictive asset ranking system is that it changes the current home inspection process (e.g., subjective and qualitative) and current report (e.g., no standardization) into a predictive asset ranking tool that provides a standardized inspection and reporting process that is objective and analytical that may be utilized in every facet of the real estate transaction.

Currently, home inspections are typically performed after the offer has been accepted and only benefits one party, the buyer, as an educational and negotiation tool. The predictive asset ranking system allows the home inspection to be done at any time, such as at the time of listing by the seller and may be shown to prospective buyers at walk-through. The seller may used the results of the home inspection to consider options, such as whether to perform repairs, sell as is, raise the sale price, lower the sale price, etc.

The predictive asset ranking system transforms the current home inspection report into a dynamic document rather than a static document with a resultant score that may serve an invaluable resource to, for example: sellers; purchasers; realtors; brokers; advertisers; mortgage providers; hazard insurance providers; mortgage insurance providers; home warranty providers; real estate appraisers; pest control companies, radon testing, water testing, surveys, environmental inspection and valuation (e.g., lead paint, asbestos, etc.), secondary markets—Fannie Mae, Freddie Mac, HUD, GE Capital; and the like.

Having a comprehensive home inspection process and report that is prepared by a well recognized home inspector and having a report that is standardized, critical, analytical, thorough and universally understood, will lead to wider acceptance by all parties involved in the asset transaction. This may lead to greater efficiencies and less friction between the parties and adds value to the transaction. The predictive asset ranking report may be developed using multiple components, sub-components, and a series of very detailed qualitative questions which results in a professional, accurate, repeatable, and in-depth assessment. The predictive asset ranking report may be prepared based on factual standards with single interpretation and the data collected, stored and assimilated develops an intrinsic value that can not be found in current home inspection processes and reports. The predictive asset ranking process may create a new paradigm by development of the inspection process and an analytical report format prerequisite to collection and assimilation of the data to be marketed both specifically and generically.

Preferably, the predictive asset ranking system utilizes cutting edge technology to support the inspection and reporting process including, for example, Internet, email, web-based software updates and downloads, computers, portable computing systems, mobile pen-top computer systems, smart phones, and the like. In addition to a standardized report and reporting process, the predictive asset ranking system and methodology may also provide a standardized training and inspection tool. Also, the predictive asset ranking system may provide for centralized scheduling, report delivery, and customer service.

The predictive asset ranking system home score may be used not only as a physical assessment of the property, but also as a financial underwriting tool. The predictive asset ranking tool may be used by buyers and real estate investors based on investment needs. For example, a low quantitative home score may be a mark for an investor, a handy man, a fixer upper, someone willing to build sweat equity, etc., while a high home score may be the mark for a first time home buyer, someone with low cash reserves for repairs and/or replacements, non-handyman, retiree, empty-nester and the like.

The predictive asset ranking system may change the way real estate business is transacted while simultaneously reducing risk to the lending industry and housing support industry. The predictive asset ranking system may revolutionize the entire real estate industry in the same way the FICO Score revolutionized the banking the early 1960's.

While the present invention has been described in connection with the exemplary embodiments of the various Figures, it is not limited thereto and it is to be understood that other similar embodiments may be used or modifications and additions may be made to the described embodiments for performing the same function of the present invention without deviating therefrom. Furthermore, it should be emphasized that a variety of computer platforms, including handheld device operating systems and other application specific operating systems are contemplated. Still further, the present invention may be implemented in or across a plurality of processing chips or devices, and storage may similarly be affected across a plurality of devices. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed:

1. A system for predictive asset ranking of property comprising:
a database receiving and storing attribute data for components of said property;
a processor that accesses said database and applies multiple analytical hierarchies to said component attribute data;
a component ranking generated by said processor for each of said components of said property, said component ranking indicative of an overall condition of each of said property components;
an overall ranking generated by said processor comprising an aggregate of said component rankings, said overall ranking indicative of an overall condition of said property;
an output system producing said overall ranking of said property to a user.

2. The system of claim 1, wherein said processor applies multiple analytical hierarchies to said component attributes in order to derive said component rankings, wherein said hierarchies are based on an efficient attribute weighing process that assigns a weighed ranking to each of said components based on responses to a series of questions relating to said component attributes.

3. The system of claim 1, wherein said predictive asset ranking system is dynamic and allows customization of said predictive asset ranking system through selection of components for inclusion in deriving said overall property ranking.

4. The system of claim 3, further comprising component software modules, wherein each component module comprises one or more levels of sub-component software modules, wherein each component and sub-component software module comprises a series of standard qualitative questions describing attributes of said component or sub-component.

5. The system of claim 4, wherein said selection of a component loads said component software module for inclusion in deriving said overall property ranking, including all of said sub-components and qualitative questions under said selected component.

6. The system of claim 4, wherein non-selection or de-selection of said component causes said component software module not to be loaded or unloaded from said derivation of said overall property ranking, including all of said sub-components and qualitative questions under said non-selected or de-selected component.

7. The system of claim 1, wherein said components further comprise major components and sub-components, wherein said major components may be selected from the group comprising: site and landscape; hard surfaces; site drainage; roofing system; building envelop; insulation and ventilation; interior finishes; appliances; HVAC; plumbing systems; and electrical systems.

8. The system of claim 1, wherein said component ranking further comprises a numerical sub-value or sub-score that numerically quantifies a condition of each of said components of said property.

9. The system of claim 1, wherein said overall ranking further comprises a numerical value or score that numerically quantifies a condition of said property.

10. The system of claim 9, wherein said numerical value or score further comprises a numerical score range, wherein the higher the numerical score, the higher the ranking of said property, and the lower the numerical score, the lower the ranking of said property.

11. The system of claim 10, wherein said numerical score range further comprises sub-ranges comprising textual descriptions of conditions of said property.

12. The system of claim 1, wherein said overall ranking further comprises a quantitative score derived from a series of qualitative questions relating to said component attributes using an analytic hierarchy process.

13. The system of claim 1, wherein each of said components is assigned a maximum possible sub-value or sub-score such that an aggregate of said maximum possible numerical sub-value or sub-score is equal to a maximum possible numerical value or score for said property.

14. The system of claim 1, wherein each of said components is assigned a weighed value used to determine said component ranking, wherein an aggregate of said component scores is equal to said overall property ranking that is possible for said property.

15. The system of claim 1, wherein said analytical hierarchies comprise Pairwise analytical hierarchies.

16. The system of claim 1, further comprising an input system for inputting said attribute data for select components of said property.

17. The system of claim 16, wherein said input system further comprises an electronic device that displays a list of possible components for evaluation, wherein said input system receives selections of components to be evaluated, wherein a series of qualitative questions pertaining to each of said selected components is displayed, and wherein said input system receives responses to said qualitative questions pertaining to attributes of said selected major components.

18. The system of claim 1, wherein each of said components comprises one or more sub-components, wherein a series of standardized and qualitative questions exists for each sub-component for capturing conditions of attributes of said sub-components.

19. The system of claim 18, wherein each sub-component is assigned a weighed value used to determine a sub-component ranking, and an aggregate of all sub-component rankings under each component is equal to said component ranking assigned to said component.

20. The system of claim 1, further comprising a hierarchical progression, wherein said hierarchical progression comprises:
said overall ranking comprising an overall total of possible points for a property, said overall total of possible points to be distributed over a plurality of components of said property based on a comparison ranking model;
said component ranking for each component comprising an overall total of possible points for said component, said overall total of possible points for said component to be distributed over a plurality of first sub-components under each of said components, each of said components to be compared for relative importance to each of the other components based on an attributes weighing process and comparison ranking model;
a first sub-component ranking for each first sub-component comprising an overall total of possible points for said first sub-component, said overall total of possible points for said first sub-component to be distributed over a plurality of second sub-components of each of said first sub-components, each of said first sub-components to be compared for relative importance to each of the other first sub-components based on an attributes weighing process and comparison ranking model; and
a second sub-component score for each second sub-component comprising an overall total of possible points for said second sub-component, said overall total of possible points for said second sub-component to be distributed over a plurality of third sub-components of each of said second sub-components, each of said second sub-components to be compared for relative importance to each of the other second sub-components based on an attributes weighing process and comparison ranking model.

21. The system of claim 20, wherein said attributes weighing process and comparison ranking model comprises a Pairwise attribute weighing process and comparison ranking model.

22. The system of claim 1, wherein said property is a single family residential home.

23. The system of claim 1, wherein said output system further comprises a database and/or a report comprising said component rankings of conditions of said components and said overall ranking of said property condition.

24. The system of claim 23, wherein said report provides an assessment of present condition and needs of said property, and future repair and replacement needs of said property.

25. The system of claim 23, wherein key data and data points from said database and/or said report may be mined, analyzed, packaged and sold to specific list markets to be used as a predictive tool in determining whether to take an action relating to said property.

26. The system of claim 1, wherein said overall property ranking may be used as a benchmark to compare one property to another property.

27. The system of claim 1, wherein said overall property ranking may be used as a predictive asset ranking tool in one or more facets of a transaction involving said property.

28. The system of claim 27, wherein said overall property ranking may be used as a predictive asset ranking tool by one or more of: sellers, purchasers, realtors, brokers, advertisers, mortgage providers, mortgage insurance providers, hazard insurance providers, home warranty providers, real estate appraisers, and secondary markets.

29. A predictive asset ranking method comprising:
providing components of a property that may be selected for evaluation;
weighing a relative importance of each component as compared to said other selected components;
assigning points to each selected component based on said weighing;
presenting a series of qualitative questions relating to attributes of each of said selected components;
receiving responses to said qualitative questions indicative of a condition of said component attributes;
calculating a component point value for each component;
deriving an overall point value for said property by aggregating said component point values; and
outputting said overall point value that is indicative of an overall condition of said property.

30. The method of claim 29, further comprising:
applying multiple analytical hierarchies to said component attributes; and
basing said analytical hierarchies on an attribute weighing process.

31. The method of claim 30, wherein said attribute weighing process further comprises:
comparing said component attributes in pairs to judge which of each pair is preferred, or has a greater amount of some quantitative property; and
basing said analytical hierarchies on an attribute weighing process of Pairwise comparisons.

32. The method of claim 29, wherein said predictive asset ranking of said property is performed at time of listing of said property for sale.

33. The method of claim 29, further comprising making said outputting said overall point value available to one or more of: a buyer, a seller, a real estate agent, a broker, a mortgage company, a mortgage insurance company, an insurance company, a lawn care company, a pest control company, a second lender.

34. The method of claim 29, further comprising providing a standardized report format wherein said standardized report includes said outputting said overall point value that is indicative of an overall condition of said property.

35. The method of claim 29, further comprising:
customizing said predictive asset ranking method for a particular property being evaluated by allowing a user to select components to be evaluated and included in said derivation of said overall point value for said property.

36. The method of claim 35, further comprising:
automatically recalculating said weighing a relative importance of each component based on said selection of said components; and
redistributing points associated with a non-selected component over said selected components that are applicable to said property being evaluated.

37. The method of claim 29, further comprising:
converting said responses to said qualitative questioning to a quantitative score by using an analytic hierarchy process.

38. The method of claim 29, further comprising:
using said overall point value as a benchmark for comparing said property to other properties.

39. The method of claim 29, further comprising:
adjusting said overall point value based upon a geographic region in which said property is located to account for regional factors that may impact said property.

40. The method of claim 29, further comprising:
determining a relative characteristic worthiness for said property based on one or more of said component point value and/or said overall point value for said property; and
making said characteristic worthiness available to property service providers for use in making a relative characteristic worthiness assessment.

41. A real property data collection and scoring system comprising:
components of a property selected for inclusion in said data collection and scoring of said real property;
weights assigned to each component for weighing a relative importance of each component as compared to other components;
points that are assigned to each selected component based on said weighing;
qualitative questions relating to attributes of each of said selected components;
attribute data received in response to said qualitative questions, said attribute data indicative of a condition of said selected components;
a point value calculated for each component based on said attribute data; and
an overall point value derived by aggregating said component point values, said overall point value being indicative of an overall condition of said property.

42. The real property data collection and scoring system of claim 41, wherein said component attribute data may be mined, analyzed, packaged and sold to specific list markets.

43. The real property data collection and scoring system of claim 41, further comprising a hierarchical progression, wherein said hierarchical progression comprises:
said overall point value comprising an overall total of points for said property, said overall total of points for said property to be distributed over a plurality of components of said property based on a comparison ranking model;
said component point value comprising an overall total of points for each of said components, said overall total of points for each of said components to be distributed over a plurality of first sub-components of each of said components, each of said components to be compared for relative importance to each of the other components based on an attributes weighing process and comparison ranking model;
a first sub-component point value for each first sub-component comprising an overall total of points for each of said first sub-components, said overall total of points for each of said first sub-component to be distributed over a plurality of second sub-components of each of said first sub-components, each of said first sub-components to be compared for relative importance to each of the other first sub-components based on an attributes weighing process and comparison ranking model for score points; and
a second sub-component point value for each second sub-component comprising an overall total of points for said second sub-components, said overall total of points for said second sub-component to be distributed over a plurality of third sub-components of each of said second sub-components, each of said second sub-components to be compared for relative importance to each of the other second sub-components based on an attributes weighing process and comparison ranking model for score points.

44. The real property data collection and scoring system of claim 41, further comprising: an estimated useful life (EUL); an estimated age; a remaining useful life (RUL); and a percent EUL depleted, wherein said EUL, said estimated age, said RUL, and said percent EUL depleted contribute to said points that are assigned to each selected component having an EUL.

45. The real property data collection and scoring system of claim 44, wherein said EUL represents an adjusted score (“component score” column plus “percent EUL depleted” point contribution), said estimated age is a sum of said percent EUL depleted for all components; and said RUL is a sum of said percent depleted EUL for all components times an average of said percent depleted column.
